(19) United States
(12) Patent Application Publication
(10) Pub. No.: US 2021/0027409 A1
(43) Pub. Date: Jan. 28, 2021

(54) Methods and Systems for Facilitating Safety and Security of Users

(71) Applicant: OLA ELECTRIC MOBILITY PRIVATE LIMITED, Bengaluru (IN)

(72) Inventors: Rakesh Sasidharan Nair, Kottayam (IN); Sathya Narayanan Nagarajan, Bengaluru (IN); Parth Suthar, Bangalore (IN); Sudhir Singh Mor, Ahmedabad (IN); Shreeyash Salunke, Pune (IN); Arjun S, Bengaluru (IN); Krishna Prasad Kuruva, Kurnool (IN); Ajit Pratap Singh, Kanpur (IN); Akul Aggarwal, Bangalore (IN); Abhinav Srivastava, Bangalore (IN); Akilan M R, Bangalore (IN)

(73) Assignee: OLA ELECTRIC MOBILITY PRIVATE LIMITED, Bengaluru (IN)

(21) Appl. No.: 16/935,524

(22) Filed: Jul. 22, 2020

(30) Foreign Application Priority Data
Jul. 23, 2019 (IN) 201941029814

(51) Int. Cl. G06Q 50/26; G06Q 50/00; G06Q 50/30; G06Q 30/02; H04W 4/90; H04W 4/40; G10L 15/08; G10L 15/22; H04N 5/232; B60R 21/01

(52) U.S. Cl. CPC G06Q 50/265; G06Q 50/01; G06Q 50/30; G06Q 30/0236; G06Q 30/0208; H04W 4/90; G10L 2015/088; G10L 15/08; G10L 15/22; H04N 5/232; B60R 21/01; G10L 2015/223; H04W 4/40

(57) ABSTRACT

A safety method and system for users in a vehicle is provided. The method includes operations that are executed by a circuitry of the system to facilitate safety features to the users. The operations include detecting an emergency input for activating a camera device to record real-time in-vehicle activities. A preferred contact of a user in the vehicle is determined and audiovisual information of the in-vehicle activities is communicated in real-time with each preferred contact. The recorded in-vehicle activities are further processed in real-time for detecting an emergency incident. An alert signal is generated based on the emergency incident, and one or more entities who can provide help are identified based on a location of the vehicle. The alert signal is communicated to the one or more entities along with the recorded in-vehicle activities.

### CROSS-RELATED APPLICATIONS

This application claims priority of Indian Non-Provisional Application No. 201941029814, filed Jul. 23, 2019, the contents of which are incorporated herein by reference.

### FIELD

Various embodiments of the disclosure relate generally to safety and security systems. More specifically, various embodiments of the disclosure relate to methods and systems for facilitating safety and security of one or more users. The methods and systems facilitate safety and security of a user by alerting one or more entities for providing one or more rescue operations in an event of a safety and security concern associated with a vehicle or the user of the vehicle.

### BACKGROUND

With the improvement in lifestyles of individuals and limited alternatives of public or private transportations, popularity for availing vehicle services is continuously increasing to travel between source and destination locations. The individuals avail the vehicle services for commuting to and from their work places, or when the individuals are engaged in personal activities. In modern cities, vehicle service providers play important roles in offering on-demand vehicle services to the individuals. Generally, a vehicle service provider, for example, an auto-rickshaw or a cab service provider is engaged in providing the on-demand vehicle services to the individuals by offering various types of vehicles (such as cars, auto-rickshaws, or the like) for their rides. In such a ride, safety and security of the individuals (such as a passenger and a driver in a 3-wheeler auto-rickshaw) becomes paramount and it is necessary to take proper rescue measures in quick time to mitigate aftereffects of any emergency incident associated with the vehicle including the individuals. The safety and security concerns are even higher when passengers, especially female passengers, are travelling in auto-rickshaws that are generally open from few sides. With these vehicles, there is high possibility of sudden intrusions, attacks, or molestations of the passengers that can cause loss of lives and properties. Therefore, a quick response is highly necessary that can help in saving human lives and minimizing collateral damages resulting therefrom. Currently, such emergency incidents and resulting consequences are on the rise due to lack of awareness, inefficient and ineffective reporting of such incidents, and delayed rescue operations. Furthermore, these auto-rickshaws lack safety and security implementations, which in turn can also encourage intruders, attackers, molesters, or the like to behave improperly with the individuals traveling in the auto-rickshaws. Such actions can cause loss of lives and properties, or any other collateral damages resulting therefrom.

In light of the foregoing, there exists a need for a technical and reliable solution that solves the above-mentioned problems and short-comings and facilitates safety and security measures to occupants of a vehicle in an effective and efficient manner, which in turn will discourage individuals, such as intruders, attackers, molesters, or the like, from behaving improperly with the occupants.

### SUMMARY

Methods and systems for facilitating safety and security of users of a vehicle are provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

FIG. 1 is a block diagram that illustrates an exemplary system environment in which various embodiments of the present disclosure are practiced;

FIG. 2 is a block diagram that illustrates a vehicle device of a vehicle of the system environment of FIG. 1, in accordance with an exemplary embodiment of the present disclosure;

FIG. 3 is a block diagram that illustrates an exemplary scenario of various safety and security operations executed by the vehicle device, in accordance with an exemplary embodiment of the present disclosure;

FIG. 4 is a block diagram that illustrates a user interface (UI) rendered on a user device of a user of the system environment of FIG. 1, in accordance with an exemplary embodiment of the present disclosure;

FIGS. 5A-5C are diagrams that collectively represent a flow chart that illustrates a safety and security method for users in the vehicle, in accordance with an exemplary embodiment of the present disclosure;

FIGS. 6A-6B are diagrams that collectively represent a flow chart that illustrates a safety and security method for the users in the vehicle, in accordance with another exemplary embodiment of the present disclosure; and

FIG. 7 is a block diagram that illustrates a system architecture of a computer system for facilitating safety and security features to the users of the vehicle, in accordance with an exemplary embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present disclosure. There may be additional components described in the foregoing application that are not indicated on one of the described drawings. In the event such a component is described, but not indicated in a drawing, the absence of such a drawing should not be considered as an omission of such design from the specification.

Before describing the present disclosure in detail, it should be observed that the present disclosure utilizes a combination of system components, which constitutes safety methods and systems for providing safety and security features to one or more users of a vehicle. Accordingly, the components and the method steps have been represented, showing only specific details that are pertinent for an understanding of the present disclosure so as not to obscure the disclosure with details that will be readily apparent to those with ordinary skill in the art having the benefit of the description herein. As required, detailed embodiments of the present disclosure are disclosed herein; however, it is to be understood that the disclosed embodiments are merely exemplary of the disclosure, which can be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure. Further, the terms and phrases used herein are not intended to be limiting but rather to provide an understandable description of the disclosure.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Terms Description (in Addition to Plain and Dictionary Meaning)

A “vehicle” is a mode of transport that is deployed by a ride-hailing service provider, such as a vehicle service provider, to provide one or more vehicle services to one or more users. For example, the vehicle is an automobile, a bus, a car, a bike, an auto-rickshaw, or the like. The one or more users may use the vehicle to commute between source and destination locations. The vehicle may be an electric vehicle, a non-electric vehicle, a semi-electric vehicle, an autonomous vehicle, or the like.

A “user” is an individual who is using a vehicle. In one example, the user is a passenger (in the vehicle) who is traveling from one location to one or more other locations using a vehicle service (such as the vehicle) offered by a vehicle service provider. For using the vehicle service, the passenger may initiate a booking request for a ride with the vehicle service provider in an online manner, and provide ride details such as a pick-up location, a drop-off location, a vehicle type, a pick-up time, or any combination thereof. In another example, the user is a driver who drives the vehicle to offer the vehicle service to the passenger. For example, based on allocation of the vehicle to the passenger by the vehicle service provider, the driver drives the vehicle to pick the passenger from the pick-up location, and then transports the passenger to the drop-off location.

An “emergency button” is a physical device installed in a vehicle that may be used by a user of the vehicle for triggering a safety or security concern associated with the vehicle or the user. The emergency button may be an electronic switch, a mechanical switch, or a combination thereof.

A “service application” is a software framework configured to execute one or more instructions to perform one or more operations associated with one or more services, for example, on-demand vehicle services offered by a vehicle service provider. For availing the on-demand vehicle services in an online manner, a user may download and install the service application on a computing device such as a laptop or a smartphone. Thereafter, the user may interact with the service application (or a remote server via the service application) for performing one or more desired operations such as initiating a booking request for a ride, requesting a ride fare for the ride, or availing other online-based in-vehicle services or features during the ride.

A “keyword” is a word or a group of words that may be uttered by a user, such as a passenger or a driver, of a vehicle. In an embodiment, the user may utter one or more keywords to raise a safety or security concern in case of an incident associated with the user or the vehicle. The one or more keywords may be analyzed by a computing device or server to validate and identify the safety or security concern, and, accordingly perform one or more operations. Thus, the one or more keywords may be indicative of one or more safety or security incidents. For example, a keyword such as “attack” may indicate a physical attack on the vehicle or the user of the vehicle. In another example, a keyword such as “accident” may indicate a crash or a collision of the vehicle with other objects. In another example, a keyword such as “misbehavior” may indicate a physical, verbal, or mental assault of the user by another user. In an embodiment, the one or more keywords (indicating the one or more safety or security incidents) may be predefined using one or more codes such as numeral codes, alphabetical codes, or a combination thereof. In such a scenario, the user may utter the one or more codes in the event of the one or more safety or security incidents.

A “streaming signal” is a signal (e.g., a broadcasting signal) that facilitates live streaming or broadcasting of an event to one or more individuals. For example, the streaming signal may facilitate live streaming or broadcasting of audiovisual information including at least one of audio and video content (captured by in-vehicle audio and camera devices, respectively) of various in-vehicle activities associated with a vehicle. In one example, the streaming signal may be automatically communicated to one or more preferred contacts of a user associated with the vehicle in an event of an emergency incident.

An “emergency incident” is an event in which action or reaction of an object, substance, individual, or the like results in damage or loss of lives and properties such as a driver, a passenger, or a vehicle. Examples of the emergency incident may include, but are not limited to, medical emergencies, accidents, physical attacks, robberies, protests, fire, scuffle, arguments, and anomalies. The emergency incident may also be associated with malfunctioning of various in-vehicle devices or components that can cause serious safety issues during a ride.

An “alert signal” is an emergency notification that indicates a potential hazard, obstacle, or condition requiring special attention. In an embodiment, the alert signal corresponding to an emergency incident (associated with at least one of a passenger, a driver of a vehicle, or the vehicle itself) may be communicated to one or more entities who may come forward to offer immediate rescue services or help at an incident location associated with the emergency incident. The alert signal may be represented by means of at least one of a visual signal, an audio signal, a light signal, a textual signal, or any combination thereof.

An “entity” is a person, a group of persons, or an organization that may provide safety and rescue services in an event of an emergency incident. For example, an entity can be a passer-by individual, a near-by vehicle, or an emergency response team such as a doctor, a security officer, a fire brigade, or the like.

“Audiovisual information” corresponds to multimedia content including at least one of audio and video content. In an embodiment, the audiovisual information may be captured and recorded by one or more in-vehicle audio and video devices (such as a video camera) installed in a vehicle. The audiovisual information may include at least one of the audio and video content corresponding to one or more in-vehicle activities.

A “location sensor” is an electronic device with antennas (e.g., a Global Positioning System (GPS) sensor) that uses a satellite-based navigation system to measure its own position on the earth. The position may be measured in terms of at least one of latitude, longitude, and altitude information.

An “identifier” is an object that is used to identify an individual. For example, the individual may be identified by a name, an email, a contact number, and so on.

A “call log” is collection, evaluation, and reporting of data corresponding to various telecommunication transactions (e.g., phone calls such as audio or video calls) associated with a user. The user may perform the various telecommunication transactions using a user device such as a mobile phone. The call log may include data indicative of a call type (e.g., an outgoing call, a missed call, and an incoming call), a call duration of each call, a source number, a destination number, and the like.

A “message log” is collection, evaluation, and reporting of data corresponding to various telecommunication transactions (e.g., text messages, audio messages, or video messages) associated with a user. The user may perform the various telecommunication transactions using a user device such as a mobile phone. The message log may include data indicative of a frequency of messages exchanged between two parties.

A “social media platform” refers to a communication medium using which one or more registered users interact with each other by performing one or more actions. For example, the one or more registered users may post, share, tweet, like, or dislike one or more messages, images, videos, or any other posts on the social media platform. Examples of the social media platform may include, but are not limited to, social networking websites (e.g., Facebook™, LinkedIn™ Twitter™, Instagram™, Google+™, and so forth), web-blogs, web-forums, community portals, online communities, or online interest groups.

A “social media profile” of a user is collection and description of various characteristics of the user that may be used to identify the user on one or more social media platforms. In an embodiment, the social media profile may include social media data of the user. The social media data may refer to data, such as one or more messages, images, videos, and/or the like, that have been posted, shared, tweeted, liked, and/or disliked by the user on the one or more social media platforms. The social media data may further include data pertaining to one or more replies, likes, and/or dislikes provided by the user on one or more messages, images, videos, and/or the like that are associated with one or more other users. In an embodiment, the social media profile of the user may be processed to identify one or more preferred contacts (such friends, family, acquaintances, or the like) of the user.

Certain embodiments of the disclosure may be found in a disclosed apparatus for providing safety and security services to one or more users of a vehicle such as a 3-wheeler auto-rickshaw. Exemplary aspects of the disclosure include a method and system for providing the safety and security services to the one or more users of the vehicle. The safety method includes one or more operations that are executed by circuitry of the system to facilitate the enhanced safety and security measures in the vehicle. To facilitate the safety and security measures in the vehicle, the circuitry may be configured to detect an emergency input initiated by a user in the vehicle. The emergency input may be initiated by the user by using one of an in-vehicle emergency button in the vehicle, a service application running on a user device of the user, or a set of keywords uttered by the user. In response to the detected emergency input, the circuitry may be further configured to activate a camera device of the vehicle. Upon activation, the camera device may be configured to capture and record real-time audiovisual information of one or more in-vehicle activities associated with the vehicle or the user in the vehicle. The circuitry may be further configured to communicate a streaming signal to one or more preferred contacts of the user based on one or more identifiers associated with each preferred contact. The streaming signal may be communicated in real-time to facilitate live streaming of the real-time audiovisual information to each preferred contact of the user. The circuitry may be further configured to process the recorded audiovisual information in real-time to detect one or more emergency events associated with at least one of the user or the vehicle. Based on the detected emergency events, the circuitry may be further configured to generate an alert signal and communicate the alert signal along with the real-time audiovisual information to one or more entities. The one or more entities may include one or more passer-by individuals, near-by vehicles, and emergency response teams. The one or more entities may come forward to offer one or more rescue operations based on at least the communicated alert signal and audiovisual information.

Another embodiment of the disclosure provides a camera device installed in a vehicle for providing the safety and security services to one or more users of the vehicle. The camera device may be configured to execute one or more operations to facilitate the enhanced safety and security measures in the vehicle. To facilitate the safety and security measures in the vehicle, the camera device may be configured to detect an emergency input initiated by a user in the vehicle. The emergency input may be initiated by the user by using one of an in-vehicle emergency button in the vehicle, a service application running on a user device of the user, or a set of keywords uttered by the user. In response to the detected emergency input, the camera device may be configured to automatically start capturing and recording of real-time audiovisual information of one or more in-vehicle activities associated with the vehicle or the user of the vehicle. The camera device may be further configured to communicate a streaming signal to one or more preferred contacts of the user based on one or more identifiers associated with each preferred contact. The streaming signal may be communicated in real-time to facilitate streaming of the real-time audiovisual information to each preferred contact of the user. The camera device may be further configured to process the recorded audiovisual information to detect one or more emergency events associated with at least one of the user or the vehicle. Based on the detected emergency events, the camera device may be further configured to generate an alert signal and communicate the alert signal along with the real-time audiovisual information to one or more entities. The one or more entities may include one or more passer-by individuals, near-by vehicles, and emergency response teams. The one or more entities may come forward to offer one or more rescue operations based on at least the communicated alert signal and audiovisual information.

Thus, the present disclosure facilitates the enhanced safety and security measures to the one or more users of the vehicle (such as the 3-wheeler auto-rickshaw) by detecting the one or more emergency events based on the capturing and processing of the one or more in-vehicle activities in real-time. In a scenario where an emergency event (such as misbehavior by a co-user) is detected, an alert signal may be generated and communicated to the one or more entities such as one or more passer-by individuals, near-by vehicles, and emergency response teams, who may come forward to offer the one or more rescue operations. Thus, the implementation of the methods and systems of the present disclosure may facilitate immediate assistance to the one or more users that can result in saving their lives and minimizing any other collateral damages resulting therefrom. Also, with the implementation of these safety and security measures in the vehicle, especially, the 3-wheeler auto-rickshaws, various individuals, such as intruders, attackers, molesters, or the like, are discouraged from behaving improperly with the one or more users of the vehicle. Thus, the present disclosure facilitates a sense of enhanced safety and security to the one or more users of the vehicle. The one or more users may feel safe and secure during their rides.

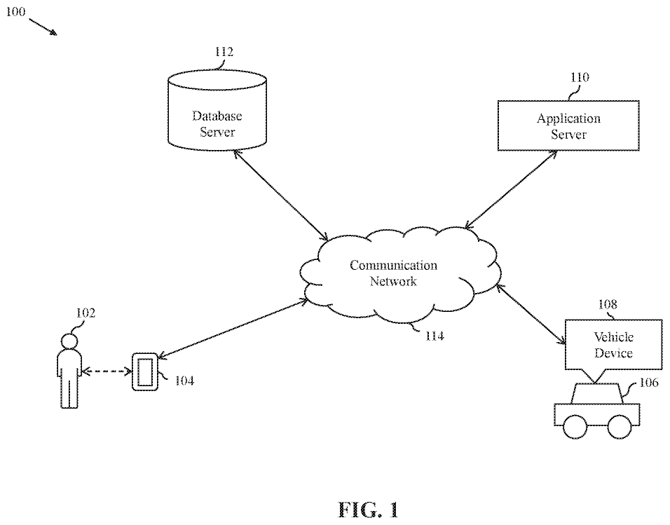

FIG. 1 is a block diagram that illustrates an exemplary system environment 100 in which various embodiments of the present disclosure are practiced. The system environment 100 includes a user 102 in possession of a user device 104, a vehicle 106 having a vehicle device 108 installed therein, an application server 110, and a database server 112. The user device 104, the vehicle device 108, the application server 110, and the database server 112 may communicate with each other via a communication network 114.

The user 102 is an individual who may be using the vehicle 106. In one example, the user 102 may be a passenger who is traveling from one location to one or more other locations using the vehicle 106 offered by a ride-hailing service provider. In another example, the user 102 may be a driver who is driving the vehicle 106. In an embodiment, in an event of a safety or security concern, an emergency input may be initiated by the user 102 by using various means. The safety or security concern may be perceived by the user 102 before or after an occurrence of an emergency event or incident (hereinafter, “the emergency incident”). For example, in case of a night ride where the driver (for example, a male driver) is driving the vehicle 106 to transport the passenger (for example, a female passenger) to a destination location, the passenger may not entirely feel safe. In such a scenario, the emergency input may be initiated by the passenger. In another example, the driver meets with an accident when the driver is driving the vehicle 106 to transport the passenger to the destination location. In such a scenario, the emergency input may be initiated by the passenger or the driver.

In an embodiment, the various means for initiating the emergency input may be facilitated by the ride-hailing service provider. For example, the ride-hailing service provider may facilitate the initiation of the emergency input by using a physical button (e.g., an emergency button) installed in the vehicle 106, a service application running on the user device 104, or one or more keywords (hereinafter, “the keywords”) uttered by the user 102. Thus, in one embodiment, the emergency input may be initiated by the user 102 by using the service application. In another embodiment, the emergency input may be initiated by the user 102 by pressing the in-vehicle emergency button. In another embodiment, the emergency input may be initiated by the user 102 by uttering the keywords (that are indicative of the emergency incident). Thus, one of the various means may be used by the user 102 to report the emergency incident or a likelihood of the occurrence of the emergency incident. Also, one of the various means may be used by the user 102 to activate one or more in-vehicle safety monitoring devices such as one or more audio and video capturing devices installed in the vehicle 106. In some embodiments, the emergency input may be automatically initiated or triggered based on the automatic detection of the emergency incident. For example, the emergency input may be automatically initiated based on deterioration in real-time health condition of the user 102 detected by one or more health-detecting-and-monitoring sensors (hereinafter, “the health sensors”) installed in the vehicle 106. In another example, the emergency input may be automatically initiated based on a collision of the vehicle 106 with an external object such as another vehicle.

The user device 104 may include suitable logic, circuitry, interfaces, and/or code, executable by the circuitry, that may be configured to perform one or more user operations. In an embodiment, the user device 104 may be a communication device that is used by the user 102 to perform the one or more user operations, such as initiating a booking request for a ride, requesting a ride fare for the ride, or availing other online-based in-vehicle services or features during the ride. The one or more user operations may be facilitated by a ride-hailing service provider platform (hosted by the application server 110) in an online manner by means of the service application running on the user device 104. Examples of the user device 104 may include, but are not limited to, a personal computer, a laptop, a smartphone, a tablet, or any other device capable of communicating via the communication network 114.

In an embodiment, the user device 104 may be used by the user 102 to communicate with the vehicle device 108, the application server 110, and the database server 112 via the communication network 114. Further, the user device 104 may be used by the user 102 to initiate the emergency input by using the service application. The service application is associated with the ride-hailing service provider platform and is communicatively coupled to the vehicle device 108, the application server 110, and the database server 112 by means of the user device 104 via the communication network 114. Various modes of inputs used by the user 102 to initiate the emergency input may include, but are not limited to, a touch-based input, a text-based input, a gesture-based input, an audio-based input, or a combination thereof.

In an embodiment, the user device 104 may be configured to store historical data of the user 102 retrieved by the service application. In another embodiment, the historical data of the user 102 may be stored in the database server 112 by the service application via the communication network 114. The historical data may include, but is not limited to, a historical call log of the user 102, a historical message log of the user 102, and a historical activity log (including a social media profile) of the user 102 on one or more social media platforms.

The vehicle 106 is a mode of transport that is used by the user 102 to commute from one location to another location. The user 102 may correspond to the driver of the vehicle 106 or the passenger of the vehicle 106. In one example, the user 102 is driving the vehicle 106 and is the sole occupant of the vehicle 106. In another example, the user 102 is driving the vehicle 106 and other users (e.g., one or more passengers) are travelling in the vehicle 106 to reach their destinations. In an exemplary scenario, the vehicle 106 may be associated with the ride-hailing service provider (for example, the ride-hailing service provider platform such as OLA) that offers on-demand vehicle services to the one or more passengers in the online manner. Based on one or more requests for one or more on-demand vehicle services by the one or more passengers, the ride-hailing service provider platform (hosted by the application server 110) may allocate one or more available vehicles (such as the vehicle 106) to the one or more passengers (such as the user 102) for one or more rides. Examples of the vehicle 106 may include, but are not limited to, an automobile, a car, an auto-rickshaw, and a bike.

In an embodiment, the vehicle 106 may include the health sensors that are integrated in different internal parts (e.g., seats or doors of the vehicle 106). The health sensors may detect and measure health data of the user 102 such as the passenger or the driver associated with the vehicle 106. For example, a set of health sensor may be configured to monitor the heart functions of the user 102. In another example, a set of health sensors may be configured to monitor the body temperature of the user 102.

In an embodiment, the vehicle 106 may also include one or more location-detecting sensors (hereinafter, “the location sensors”). The location sensors may detect and measure their real-time location information, which in turn may indicate real-time location information of the vehicle 106. In an embodiment, the vehicle 106 may also include the one or more audio and video capturing devices (hereinafter, “a camera device”). The camera device may facilitate capturing, recording, and/or processing of one or more in-vehicle activities. In an embodiment, the vehicle 106 may also include the in-vehicle emergency button that may be used by the user 102 to trigger the emergency input in case of the emergency incident. In an embodiment, the vehicle 106 may also include one or more computing devices, such as the vehicle device 108, that may be communicatively coupled to the user device 104, the application server 110, and the database server 112 via the communication network 114. The one or more computing devices may also be communicatively coupled to the health sensors, the location sensors, the camera device, and the in-vehicle emergency button of the vehicle 106.

The vehicle device 108 may include suitable logic, circuitry, interfaces and/or code, executable by the circuitry, that may be configured to perform one or more operations for monitoring vehicle's operation and in-vehicle activities, and facilitating the safety and security services to the one or more users during a ride in real-time. In an embodiment, the vehicle device 108 may be a computing device, a software framework, or a combination thereof that performs one or more dedicated operations. Various operations of the vehicle device 108 may be dedicated to execution of procedures, such as, but are not limited to, programs, routines, or scripts stored in its memory for supporting its applied applications. Examples of the vehicle device 108 may include, but are not limited to, a personal computer, a laptop, or a network of computer systems. The vehicle device 108 may be realized through various web-based technologies such as, but are not limited to, a Java web-framework, a .NET framework, a PHP (Hypertext Preprocessor) framework, or any other web-application framework. The vehicle device 108 may further be realized through various embedded technologies such as, but are not limited to, microcontrollers or microprocessors that are operating on one or more operating systems such as Windows, Android, Unix, Ubuntu, Mac OS, or the like.

In an embodiment, the vehicle device 108 may be configured to detect the emergency input initiated by the user 102. The emergency input may be initiated by the user 102 by using at least one of the in-vehicle emergency button, the service application, or the uttered keywords. In response to the detected emergency input, the vehicle device 108 may be configured to activate the camera device for capturing and recording the real-time audiovisual information corresponding to the one or more in-vehicle activities. The one or more in-vehicle activities may be related to at least one or more users (such as the user 102) who are inside the vehicle 106 or in the vicinity of the vehicle 106.

In another embodiment, the vehicle device 108 may be configured to receive the health data of the user 102 from the health sensors associated with the vehicle 106. The vehicle device 108 may be further configured to monitor and process the health data of the user 102 and determine the real-time health condition of the user 102. When the determination indicates that the health condition of the user 102 is not normal (for example, a heart rate of the user 102 is greater than a defined threshold rate), the vehicle device 108 may automatically initiate or trigger the emergency input and activate the camera device of the vehicle 106 for capturing and recording the real-time audiovisual information.

Further, in an embodiment, the vehicle device 108 may be configured to determine one or more preferred contacts (hereinafter, “the preferred contacts”) of the user 102. In one embodiment, the preferred contacts may be determined based on one or more preferences for one or more contacts defined by the user 102 by using the service application. The preferred contacts may be defined by the user 102 at the time of registration or at the time of initiation of a new ride request for a ride with the ride-hailing service provider platform, and provide one or more identifiers, such as a name, an email, a contact number, or the like, for each preferred contact. In another embodiment, the preferred contacts may be determined based on the historical data (such as the call log, the message log, or the activity log on the one or more social media platforms) of the user 102. For example, the vehicle device 108 may retrieve the historical data of the user 102 from the user device 104 or the database server 112 and process the retrieved historical data to determine a list of individuals with whom the user 102 communicates more frequently. For example, if the user 102 communicates at least 5 times with an individual over a call in a day, the individual may be identified as a preferred contact for the user 102. Similarly, other preferred contacts for the user 102 may be identified.

Upon determination of the preferred contacts, the vehicle device 108 may be further configured to generate and communicate a streaming signal to the preferred contacts of the user 102. The streaming signal may be communicated to the preferred contacts of the user 102 based on the one or more identifiers associated with each preferred contact. The streaming signal may facilitate each preferred contact to stream the real-time audiovisual information on a computing device associated with the preferred contact.

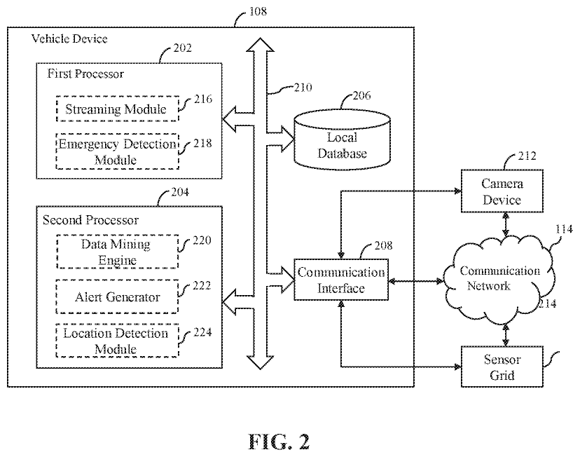

Further, in an embodiment, the vehicle device 108 may be configured to process the recorded audiovisual information to detect one or more emergency events or incidents (hereinafter, “the one or more emergency incidents”) associated with at least one of the user 102 or the vehicle 106. For example, the vehicle device 108 may process real-time audio data including one or more specific keywords such as “HELP ATTACK” and determine that the user 102 may have been attacked by another individual. In such a case, the vehicle device 108 may detect the emergency incident as “physical attack” and generate an alert signal. The vehicle device 108 may be further configured to identify a degree of severity of the emergency incident, and accordingly assign a priority of emergency to the emergency incident. The vehicle device 108 may be further configured to determine an incident location associated with the emergency incident based on the location information of the vehicle 106. Based on the incident location, the vehicle device 108 may identify one or more entities, including one or more passer-by individuals, near-by vehicles, and emergency response teams, from a set of entities associated with a geographical region (including the incident location) in which the vehicle 106 is currently operating. Thereafter, the vehicle device 108 may be configured to communicate the alert signal along with the real-time audiovisual information and the location information (including the incident location) to the one or more entities. Various operations of the vehicle device 108 have been further described in detail in conjunction with FIGS. 2, 3, 4, 5A-5C, 6A-6B, and 7.

The application server 110 may include suitable logic, circuitry, interfaces, and/or code, executable by the circuitry, that may be configured to perform one or more operations for monitoring vehicle's operation and in-vehicle activities, and facilitating the safety and security services to the one or more users during a ride in real-time. The application server 110 may be a computing device, which may include a software framework, that may be configured to create the application server implementation and perform the various dedicated operations. The application server 110 may be realized through various web-based technologies, such as, but are not limited to, a Java web-framework, a .NET framework, a professional hypertext preprocessor (PHP) framework, a python framework, or any other web-application framework. The application server 110 may be further realized through various embedded technologies such as, but are not limited to, microcontrollers or microprocessors that are operating on one or more operating systems such as Windows, Android, Unix, Ubuntu, Mac OS, or the like. The application server 110 may also be realized as a machine-learning model that implements any suitable machine-learning techniques, statistical techniques, or probabilistic techniques. Examples of such techniques may include expert systems, fuzzy logic, support vector machines (SVM), Hidden Markov models (HMMs), greedy search algorithms, rule-based systems, Bayesian models (e.g., Bayesian networks), neural networks, decision tree learning methods, other non-linear training techniques, data fusion, utility-based analytical systems, or the like. Examples of the application server 110 may include, but are not limited to, a personal computer, a laptop, or a network of computer systems. The application server 110 may also be implemented as a cloud-based server.

In an embodiment, the application server 110 may be configured to detect the emergency input initiated by the user 102. In response to the detected emergency input, the application server 110 may be further configured to activate the camera device for capturing and recording the real-time audiovisual information corresponding to the one or more in-vehicle activities. The one or more in-vehicle activities may be related to at least the one or more users (such as the user 102) who are inside the vehicle 106 or in the vicinity of the vehicle 106.

In another embodiment, the application server 110 may be further configured to receive the health data of the user 102 from the health sensors (or the vehicle device 108) associated with the vehicle 106. The application server 110 may be further configured to monitor and process the health data of the user 102 and determine the real-time health condition of the user 102. When the determination indicates that the health condition of the user 102 is not normal (i.e., a breathing rate of the user 102 is less than a defined threshold rate), the application server 110 may remotely activate the camera device of the vehicle 106 for capturing and recording the real-time audiovisual information. Alternatively, the application server 110 may generate and communicate an activation signal to the vehicle device 108 or the camera device of the vehicle 106 for the activation of the camera device of the vehicle 106 for capturing and recording the real-time audiovisual information.

Further, the application server 110 may be configured to determine the preferred contacts of the user 102, in a way as described above. Upon determination of the preferred contacts, the application server 110 may be further configured to generate and communicate the streaming signal to each preferred contact of the user 102. The streaming signal may be communicated to the preferred contacts of the user 102 based on the one or more identifiers associated with each preferred contact. The streaming signal may facilitate each preferred contact to stream the real-time audiovisual information on a computing device associated with the preferred contact.

Further, in an embodiment, the application server 110 may be configured to process the recorded audiovisual information to detect the one or more emergency incidents associated with at least one of the user 102 or the vehicle 106. For example, the application server 110 may process real-time audio-video data including one or more specific keywords such as “ACCIDENT” and determine that the vehicle 106 may have collided with an external object. In such a case, the application server 110 may detect the emergency incident as “accident” and generate an alert signal. The application server 110 may be further configured to identify a degree of severity of the emergency incident, and accordingly assign a priority of the emergency to the emergency incident. The application server 110 may be further configured to determine an incident location associated with the emergency incident based on the location information of the vehicle 106. Based on the incident location, the application server 110 may identify the one or more entities, such as one or more passer-by individuals, near-by vehicles, and emergency response teams, from the set of entities associated with a geographical region (including the incident location) in which the vehicle 106 is currently operating. Thereafter, the application server 110 may be configured to communicate the alert signal along with the real-time audiovisual information and the location information (including the incident location) to the one or more entities. Various operations of the application server 110 will be the same as described in detail for the vehicle device 108 in conjunction with FIGS. 2, 3, 4, 5A-5C, 6A-6B, and 7.

The database server 112 may include suitable logic, circuitry, interfaces, and/or code, executable by the circuitry, that may be configured to perform one or more database operations, such as receiving, storing, processing, and transmitting queries, data, or content. The database server 112 may be a data management and storage computing device that is communicatively coupled to the user device 104, the vehicle device 108, and the application server 110 via the communication network 114 to perform the one or more database operations. Examples of the database server 112 may include, but are not limited to, a personal computer, a laptop, or a network of computer systems.

In an embodiment, the database server 112 may be configured to manage and store user information pertaining to a user account of the user 102 registered with the ride-hailing service provider platform. The database server 112 may be further configured to manage and store allocation information associated with the vehicle 106. The database server 112 may be further configured to manage and store the historical data of the user 102 and the one or more identifiers (such as a name, a contact number, an email, and the like) associated with each preferred contact. The database server 112 may be further configured to manage and store the recorded audiovisual information and the location information associated with the vehicle 106. The database server 112 may be further configured to manage and store an event dictionary including various keywords and the related emergency incident associated with each keyword. Such event dictionary may be used by the vehicle device 108 or the application server 110 to detect an occurrence of the emergency input and a type of the emergency incident. The database server 112 may be further configured to manage and store other types of information such as real-time route information, traffic information, and weather information of one or more routes including at least a route along which the vehicle 106 is currently operating. Such real-time route information, traffic information, and weather information of the one or more routes along with the location information of the vehicle 106 may be used by the vehicle device 108 or the application server 110 to determine the shortest path for reaching the incident location. Such shortest path information may be particularly useful for the one or more entities who want to provide the assistance to the one or more users (such as the user 102) of the vehicle 106.

In an embodiment, the database server 112 may be further configured to receive a query from the vehicle device 108 or the application server 110 via the communication network 114. The query may be an encrypted message that is decoded by the database server 112 to determine one or more requests for retrieving requisite information stored therein. In response to the determined one or more requests, the database server 112 may be configured to retrieve and communicate the requested information to the vehicle device 108 or the application server 110 via the communication network 114. The database server 112 may be implemented as a cloud-based server. Examples of the database server 112 may include, but are not limited to, Hadoop®, MongoDB®, MySQL®, NoSQL®, and Oracle®.

The communication network 114 may include suitable logic, circuitry, interfaces, and/or code, executable by the circuitry, that may be configured to transmit queries, messages, data, and requests between various entities, such as the user device 104, the vehicle device 108, the application server 110, and the database server 112. Examples of the communication network 114 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities in the system environment 100 may be coupled to the communication network 114 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIG. 2 is a block diagram that illustrates the vehicle device 108 of the vehicle 106, in accordance with an exemplary embodiment of the present disclosure. The vehicle device 108 includes circuitry such as a first processor 202, a second processor 204, a local database 206, and a communication interface 208 that communicate with each other by way of a communication bus 210. The vehicle device 108 may communicate with a camera device 212 and a sensor grid 214 by way of the communication interface 208. The camera device 212 and the sensor grid 214 may be integrated or installed inside the vehicle 106. The sensor grid 214 may be communicatively coupled to one or more in-vehicle sensors, such as the health sensors, the location sensors, or the like, that are installed in the vehicle 106.

The first processor 202 may include suitable logic, circuitry, interfaces, and/or code, executable by the circuitry, that may be configured to perform one or more operations. Examples of the first processor 202 may include, but are not limited to, a digital signal processor (DSP), an application-specific integrated circuit (ASIC) processor, a reduced instruction set computing (RISC) processor, a complex instruction set computing (CISC) processor, and a field-programmable gate array (FPGA). It will be apparent to a person of ordinary skill in the art that the first processor 202 may be compatible with multiple operating systems.

In an embodiment, the first processor 202 may be configured to control and manage various functionalities and operations such as detecting the emergency input initiated by the user 102, activating the camera device 212 upon detection of the emergency input to capture and record the audiovisual information of the one or more in-vehicle activities, and detecting the one or more emergency incidents by processing the recorded audiovisual information. In an embodiment, the first processor 202 may include one or more functional blocks or circuitry such as a streaming module 216 and an emergency detection module 218.

The second processor 204 may include suitable logic, circuitry, interfaces, and/or code, executable by the circuitry, that may be configured to perform one or more operations. Examples of the second processor 204 may include, but are not limited to, a DSP, an ASIC processor, a RISC processor, a CISC processor, and an FPGA. It will be apparent to a person of ordinary skill in the art that the second processor 204 may be compatible with multiple operating systems.

In an embodiment, the second processor 204 may be configured to control and manage various functionalities and operations such as obtaining the historical data of the user 102, obtaining the location information of the vehicle 106, identifying the one or more entities who may offer immediate rescue, generating one or more alert signals based on the one or more emergency incidents detected by the first processor 202, and communicating the one or more alert signals to the one or more entities. The second processor 204 may include one or more functional blocks or circuitry such as a data mining engine 220, an alert generator 222, and a location detection module 224.

The local database 206 may include suitable logic, circuitry, interfaces, and/or code, executable by the circuitry, that may be configured to store one or more instructions that are executed by the first and second processors 202 and 204 to perform their corresponding operations. In an embodiment, the local database 206 may be configured to temporarily store the historical data of the user 102, the detected emergency input, the recorded in-vehicle activities, the one or more identifiers of each preferred contact of the user 102, and communication particulars of the one or more rescue entities. In an embodiment, the local database 206 may be further configured to temporarily store sensor data detected and recorded by one or more sensors of the sensor grid 214, the location information, the one or more alert signals, the streaming signal, the recorded audiovisual information, or the like. In an embodiment, the local database 206 may be further configured to temporarily store the event dictionary including various keywords and the related emergency incident associated with each keyword. In an embodiment, the local database 206 may be further configured to manage and store other types of information such as the real-time route information, the traffic information, and the weather information of the one or more routes including at least the route along which the vehicle 106 is currently operating. Examples of the local database 206 may include, but are not limited to, a random-access memory (RAM), a read-only memory (ROM), a programmable ROM (PROM), and an erasable PROM (EPROM).

The communication interface 208 may include suitable logic, circuitry, interfaces, and/or code, executable by the circuitry, that may be configured to provide a platform or a medium for communication between various devices or servers. The communication interface 208 may be configured to allow the vehicle device 108 to transmit (or receive) data to (or from) various servers or devices, such as the user device 104, the application server 110, and the database server 112 via the communication network 114. The communication interface 208 may be further configured to enable the vehicle device 108 to communicate with the camera device 212 and the sensor grid 214 of the vehicle 106. Examples of the communication interface 208 may include, but are not limited to, an antenna, a radio frequency transceiver, a wireless transceiver, and a Bluetooth transceiver. The communication interface 208 may facilitate the communication platform or medium using various wired and wireless communication protocols, such as TCP/IP, UDP, LTE communication protocols, or any combination thereof.

The communication bus 210 may include suitable logic, circuitry, interfaces, and/or code, executable by the circuitry, that may be configured to provide a platform or a medium for communication between various internal devices of the vehicle device 108. For example, the first processor 202, the second processor 204, the local database 206, and the communication interface 208 may communicate with each other via the communication bus 210. In an embodiment, the communication bus 210 may be a parallel or serial bus. Examples of the communication bus 210 may include, but are not limited to, a serial AT attachment (SATA), an external SATA, a Peripheral Component Interconnect Express (PCI Express), and a universal serial bus (USB).

The camera device 212 may include suitable logic, circuitry, interfaces, and/or code, executable by the circuitry, that may be configured to perform one or more operations such as, but are not limited to, image capturing, video capturing, and multimedia analysis. In an embodiment, the camera device 212 may be configured to activate itself upon the initiation of the emergency input by the user 102. Upon activation, the camera device 212 may initiate capturing and recording of the audiovisual information including the one or more in-vehicle activities, and transmit the recorded audiovisual information to the vehicle device 108 in real-time. In an embodiment, the camera device 212 may include wide angle lens to capture each of the one or more users (such as the user 102) of the vehicle 106 as well as an entrance to the vehicle 106. This is particularly useful for the vehicle 106, such as an autorickshaw, which has open entrances. The camera device 212 may be further equipped with other features such as thermal imaging, low light imaging, and other advanced technological features for capturing and recording the audiovisual information. Thermal imaging features may be used to determine possible fire hazards, presence of harmful gases, or medical discomfort of the user 102. Low light imaging features may be used to improve visibility in dimly lit environments.

A person having ordinary skills in the art would understand that the various operations of the camera device 212 is not limited to capturing and recording of the audiovisual information. In an embodiment, the camera device 212 may be configured to detect the emergency input initiated by the user 102. In response to the detected emergency input, the camera device 212 may be further configured to activate itself and initiate capturing and recording of the audiovisual information corresponding to the one or more in-vehicle activities. In another embodiment, the camera device 212 may be configured to automatically monitor and process the health data of the user 102 received from the health sensors and determine the real-time health condition of the user 102. When the health condition of the user 102 is not normal (i.e., blood pressure of the user 102 is less than a defined threshold rate), the camera device 212 may activate itself automatically and initiate capturing and recording of the audiovisual information.

Further, the camera device 212 may be configured to determine the preferred contacts of the user 102, in a way as described above. Upon determination of the preferred contacts, the camera device 212 may be further configured to generate and communicate the streaming signal to each preferred contact of the user 102. The streaming signal may be communicated to the preferred contacts of the user 102 based on the one or more identifiers associated with each preferred contact.

Further, in an embodiment, the camera device 212 may be configured to process the recorded audiovisual information to detect the one or more emergency incidents associated with at least one of the user 102 or the vehicle 106. The camera device 212 may be further configured to generate the alert signal based on the detected one or more emergency incidents. The camera device 212 may be further configured to identify a degree of severity of the emergency incident, and accordingly assign a priority of the emergency to the emergency incident. The camera device 212 may be further configured to determine an incident location associated with the emergency incident based on the location information of the vehicle 106. Based on the incident location, the camera device 212 may identify the one or more entities, such as one or more passer-by individuals, near-by vehicles, and emergency response teams, from the set of entities associated with a geographical region (including the incident location) in which the vehicle 106 is currently operating. Thereafter, the camera device 212 may be configured to communicate the alert signal along with the real-time audiovisual information to the one or more entities including one or more passer-by individuals, near-by vehicles, and emergency response teams. The camera device 212 may further communicate the location information including the incident location and emergency priority to the one or more entities.

When the one or more entities provide help or rescue operations corresponding to the emergency incident, the ride-hailing service provider platform may offer one or more rewards, including at least a flat discount for a ride, a distance-based discount for a ride, a time-based discount for a ride, a reward point, or a free ride offer, to the one or more entities. The one or more rewards may be customized or dynamically updated in real-time based on the emergency priority of the alert signal. The one or more entities may be eligible for the one or more rewards when the one or more entities are registered with the ride-hailing service provider platform.

The sensor grid 214 may include suitable logic, circuitry, interfaces, and/or code, executable by the circuitry, that may be configured to perform one or more operations. In an embodiment, the sensor grid 214 may include the one or more sensors that are configured to sense or detect one or more respective signals or data, record the one or more respective signals or data, process the one or more respective signals or data, and/or communicate the one or more respective signals or data to other devices or servers. The one or more sensors may be analog sensors, digital sensors, or any combination thereof. The sensor grid 214 may include at least one or more location sensors for measuring real-time location information (in terms of longitude, latitude, and altitude) of the vehicle 106. The sensor grid 214 may include one or more health sensors for measuring one or more health parameters of the user 102. The one or more health sensors may further monitor the health conditions of the user 102 based on the one or more health parameters. Additionally, the sensor grid 214 may also include a coolant temperature sensor that measures the temperature of the coolant of the vehicle 106. The sensor grid 214 may also include an intake air temperature sensor that measures the air temperature flowing to the engine of the vehicle 106. The sensor grid 214 may also include a knock sensor that monitors detonations from the engine. The sensor grid 214 may also include a fuel temperature sensor that measures the fuel temperature of the vehicle 106.

In an embodiment, the sensor grid 214 may be communicatively coupled to the vehicle device 108, the application server 110, and the camera device 212. After measuring, recording, and/or processing of the one or more respective signals or data, the sensor grid 214 may be configured to communicate the one or more respective signals or data to at least one of the vehicle device 108, the application server 110, or the camera device 212 for further processing and analysis. The further processing and analysis of the one or more respective signals or data may be used for detecting the one or more emergency incidents associated with at least one of the user 102 or the vehicle 106.

The streaming module 216 may include suitable logic, circuitry, interfaces, and/or code, executable by the circuitry, that may be configured to perform one or more streaming operations. Based on the one or more emergency incidents, the streaming module 216 may be configured to receive the recorded audiovisual information from the camera device 212. The streaming module 216 may be further configured to generate the streaming signal for streaming the real-time audiovisual information. Further, upon determination of the preferred contacts, the streaming module 216 may be configured to communicate the streaming signal to the preferred contacts of the user 102 for streaming the audiovisual information in real-time. The streaming module 216 may be implemented by one or more processors, such as, but are not limited to, an ASIC processor, a RISC processor, a CISC processor, and an FPGA processor. Further, the streaming module 216 may include a machine-learning model that implements any suitable machine-learning techniques, statistical techniques, or probabilistic techniques for performing one or more streaming operations.

The emergency detection module 218 may include suitable logic, circuitry, interfaces, and/or code, executable by the circuitry, that may be configured to perform one or more incident detection operations. Based on the detection of the emergency input, the emergency detection module 218 may be configured to receive the recorded audiovisual information from the camera device 212. Alternatively, the emergency detection module 218 may be configured to receive the sensor data or signals from the sensor grid 214. The emergency detection module 218 may be configured to process the recorded audiovisual information and/or the sensor data or signals to detect the one or more emergency incidents. Examples of the one or more emergency incidents may include, but are not limited to, medical emergencies, accidents, physical attacks, robberies, protests, fire, scuffle, arguments, and anomalies. For example, the emergency detection module 218 may detect fire inside the vehicle 106, or a presence of a flammable substance that can cause a possible fire hazard. The emergency detection module 218 may be implemented by one or more processors, such as, but are not limited to, an ASIC processor, a RISC processor, a CISC processor, and an FPGA processor. Further, the emergency detection module 218 may include a machine-learning model that implements any suitable machine-learning techniques, statistical techniques, or probabilistic techniques for performing one or more incident detection operations.

The data mining engine 220 may include suitable logic, circuitry, interfaces, and/or code, executable by the circuitry, that may be configured to perform one or more data mining operations. In an embodiment, the data mining engine 220 may be configured to extract the recorded audiovisual information from the local database 206 or the camera device 212. The data mining engine 220 may be further configured to extract the historical data of the user 102 from the user device 104 or the database server 112. The historical data may include, but is not limited to, the historical call log of the user 102, the historical message log of the user 102, and the historical activity log of the user 102 on the one or more social media platforms. The historical data may be used to determine the preferred contacts of the user 102. Alternatively, the data mining engine 220 may extract the preferred contacts of the user 102 from the user device 104 or the database server 112. The preferred contacts may have been defined by the user 102 at the time of registration or at the time of initiation of a new ride request for a ride with the ride-hailing service provider platform. Each preferred contact may include the one or more identifiers such as a name, an email, a contact number, or the like. The data mining engine 220 may be implemented by one or more processors, such as, but are not limited to, an ASIC processor, a RISC processor, a CISC processor, and an FPGA processor. Further, the data mining engine 220 may include a machine-learning model that implements any suitable machine-learning techniques, statistical techniques, or probabilistic techniques for performing the one or more data mining operations.

The alert generator 222 may include suitable logic, circuitry, interfaces, and/or code, executable by the circuitry, that may be configured to perform one or more alert generation operations. In an embodiment, the alert generator 222 may be configured to generate the one or more alert signals based on the one or more emergency incidents. For example, upon detection of an emergency incident, the alert generator 222 may determine a context of the emergency incident (i.e. “accident” in case of a vehicle crash, or “physical attack” in case of an attack on the user 102 by another individual), and accordingly generate an alert signal. The alert generator 222 may be further configured to identify a severity of the detected emergency incident and assign a priority level to the emergency incident. The priority level may indicate a severity of the emergency incident and the required swiftness for initiation of a rescue operation. The alert generator 222 may be implemented by one or more processors, such as, but are not limited to, an ASIC processor, a RISC processor, a CISC processor, and an FPGA processor. Further, the alert generator 222 may include a machine-learning model that implements any suitable machine-learning techniques, statistical techniques, or probabilistic techniques for performing the one or more alert generation operations.

The location detection module 224 may include suitable logic, circuitry, interfaces, and/or code, executable by the circuitry, that may be configured to perform one or more location detection operations. In an embodiment, the location detection module 224 may be configured to receive the real-time location information from the sensor grid 214, process the real-time location information, and determine a real-time location (such as the incident location) associated with the vehicle 106. In an exemplary embodiment, the location detection module 224 may communicate with the location sensors of the sensor gird 214 to determine the real-time location of the vehicle 106. In another exemplary embodiment, the location detection module 224 may communicate with the user device 104 (of the user 102 who is in the vehicle 106) to determine the real-time location of the vehicle 106. In an embodiment, the incident location (i.e., the real-time location of the user 102 or the vehicle 106) may be used to identify the one or more entities (such as an emergency response team in a nearby area) and determine a response time for the one or more entities to reach the incident location. The alert signal may be communicated to the one or more entities along with the recorded audiovisual information, the priority level of the emergency incident, and the incident location. The one or more entities such as one or more emergency response teams may initiate a swift and more efficient rescue operation when they have the detailed knowledge of the one or more in-vehicle activities corresponding to the emergency incident. For example, in case of a medical emergency, a nearby doctor, with whom the alert signal was communicated, may understand from the recorded video of the one or more in-vehicle activities, exact discomfort or illness of the user 102. Similarly, when a vehicle accident occurs, the rescue entities may respond more efficiently when they know the impact damage, number of casualties, suffered injuries, number of children and women, and other information that can increase the efficiency of the rescue operation. The location detection module 224 may be implemented by one or more processors, such as, but are not limited to, an ASIC processor, a RISC processor, a CISC processor, and an FPGA processor. Further, the location detection module 224 may include a machine-learning model that implements any suitable machine-learning techniques, statistical techniques, or probabilistic techniques for performing the one or more location detection operations.

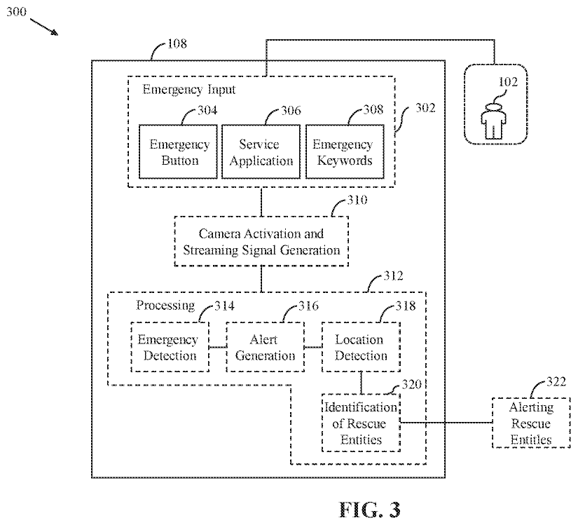

FIG. 3 is a block diagram that illustrates an exemplary scenario 300 of various safety and security operations executed by the vehicle device 108, in accordance with an exemplary embodiment of the present disclosure. The exemplary scenario 300 depicts the safety and security operations in broadly three stages such as detection of an emergency input initiated by the user 102 (as indicated by the block 302), activation of the camera device 212 and generation of the streaming signal (as indicated by block 310), and processing information recorded by the camera device 212 to detect and process an emergency incident (as indicated by block 312).

The vehicle device 108 may be configured to detect an initiation of the emergency input 302 by the user 102. The user 102 may initiate the emergency input 302 by various means. In one example, the user 102 initiates the emergency input 302 by pressing the in-vehicle emergency button (such as an emergency button 304 installed in the vehicle 106). In another example, the user 102 initiates the emergency input 302 by using the service application (such as a service application 306 running on the user device 104). In another example, the user 102 initiates the emergency input 302 by uttering the one or more keywords (such as one or more emergency keywords 308 indicative of one or more emergency incidents). The vehicle device 108 may include one or more audio processors that are configured to extract and filter out such emergency keywords from all the words (normal communication) uttered by the user 102 in real-time, by analyzing a weightage on pronunciation of words or pitch of words spoken by the user 102.

Upon detection of the emergency input 302, the vehicle device 108 may be configured to activate the camera device 212 for capturing and recording the audiovisual information. The camera device 212 may include a sophisticated camera with advanced technological features such as, but are not limited to, thermal imaging and ultra-low light imaging for capturing and recording the audiovisual information. The vehicle device 108 may be further configured to determine the preferred contacts of the user 102. In an exemplary embodiment, the vehicle device 108 may determine the preferred contacts based on the one or more preferences defined by the user 102 for the preferred contacts by means of the service application 306. In another exemplary embodiment, the vehicle device 108 may determine the preferred contacts based on the historical data of the user 102. Upon determination of the preferred contacts, the vehicle device 108 may be further configured to generate the streaming signal, and communicate the streaming signal to each preferred contact based on the one or more identifiers associated with each preferred contact. The streaming signal is a broadcasting signal that facilitates live streaming or broadcasting of the real-time audiovisual information corresponding to the one or more in-vehicle activities to the preferred contacts. A preferred contact may alert the one or more entities if some unusual activities are happening with the vehicle 106 or the user 102, especially in case of the vehicle 106 like an autorickshaw. For example, the preferred contact may report trouble caused by another autorickshaw (the wide lens of the camera device 212 may capture the view around the open entrance of the autorickshaw) that is continuously chasing from behind, to an entity such as a police officer associated with the incident location.

Further, the vehicle device 108 may be further configured to automatically detect the one or more emergency incidents (as represented by the block 314), by processing the real-time feed of the audiovisual information. For example, the vehicle device 108 processes real-time audio data when the user 102 shouts specific keywords such as “HELP” in the vehicle 106 and determines that the user 102 has been attacked by another individual. In another example, the vehicle device 108 processes real-time video data to detect a potential emergency incident such as a fire hazard (using thermal imaging to detect flammable substances). The vehicle device 108 may be further configured to analyze a severity of the emergency incident and accordingly assigns the priority level to the emergency incident. The priority level indicates a degree of swiftness required for initiation of a rescue operation. The vehicle device 108 may be further configured to generate the alert signal based on the priority level of the emergency incident (as represented by block 316). The vehicle device 108 may be further configured to determine the incident location associated with the emergency incident (as represented by the block 318) by of the location sensors or the service application 306. The vehicle device 108 may be further configured to identify the one or more entities (as represented by block 320) in a surrounding area of the vehicle 106, based on the location information of the vehicle 106. The vehicle device 108 may be further configured to alert the one or more entities (as represented by block 322) by communicating the alert signal to the one or more entities. In an example, the vehicle device 108 may communicate the alert signal to the one or more entities (such as one or more passer-by individuals or near-by vehicles) who are registered members of the ride-hailing service provider platform. The ride-hailing service provider platform may offer the one or more rewards, such as a flat discount for a ride, a distance-based discount for a ride, a time-based discount for a ride, a reward point, or a free ride offer, to the one or more entities who offer one or more rescue operations corresponding to the one or more emergency events. In another example, the vehicle device 108 may communicate the alert signal along with the recorded audiovisual information, the priority level of the emergency incident, and/or the incident location to the one or more entities (such as one or more emergency response teams). With the knowledge of the one or more in-vehicle activities at the time of the emergency incident, the one or more entities (such as emergency response team) may initiate a swift and more efficient rescue operation.

It will be apparent to a person having ordinary skill in the art that the scenario 300 and the examples have been used for illustrative purposes only and should not be construed to limit the scope of the present disclosure.

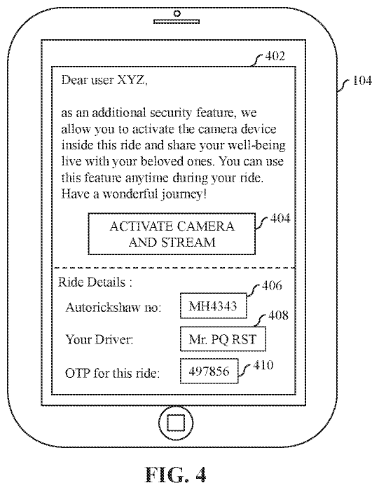

FIG. 4 is a block diagram that illustrates a user interface 402 rendered on the user device 104 of the user 102, in accordance with an exemplary embodiment of the present disclosure. The user interface 402 presents a message to the user 102 regarding an additional safety feature of in-vehicle camera (such as the camera device 212) inside the vehicle 106. The user interface 402 further presents an option 404 to the user 102 for activating the camera device 212. When the user 102 selects the option 404, the vehicle device 108 activates the camera device 212. The vehicle device 108 further generates the streaming signal to facilitate the live streaming of the audiovisual information associated with at least the vehicle 106 or the user 102. The vehicle device 108 further identifies the preferred contacts of the user 102 and communicates the streaming signal to the preferred contacts. The user interface 402 further presents various display fields that provide details about the booked ride such as, but not limited to, a display field 406 that represents a vehicle number of the vehicle 106, a display field 408 that represents a name of a driver of the vehicle 106, and a display field 410 that represents a one-time-password associated with the ride for authorization purposes.

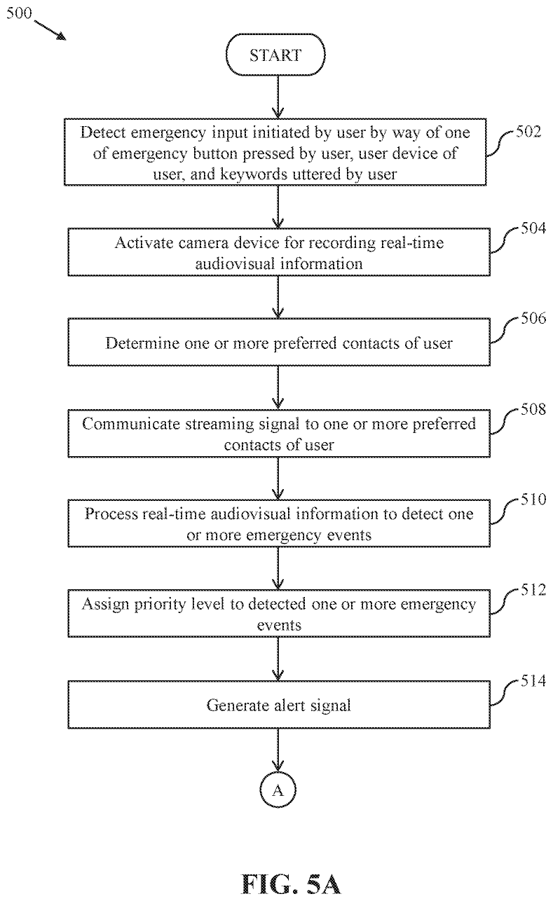

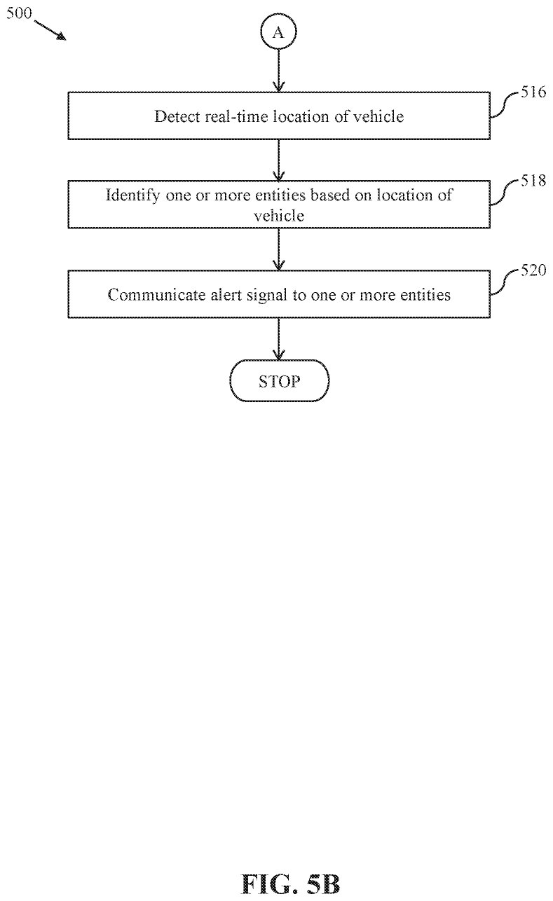

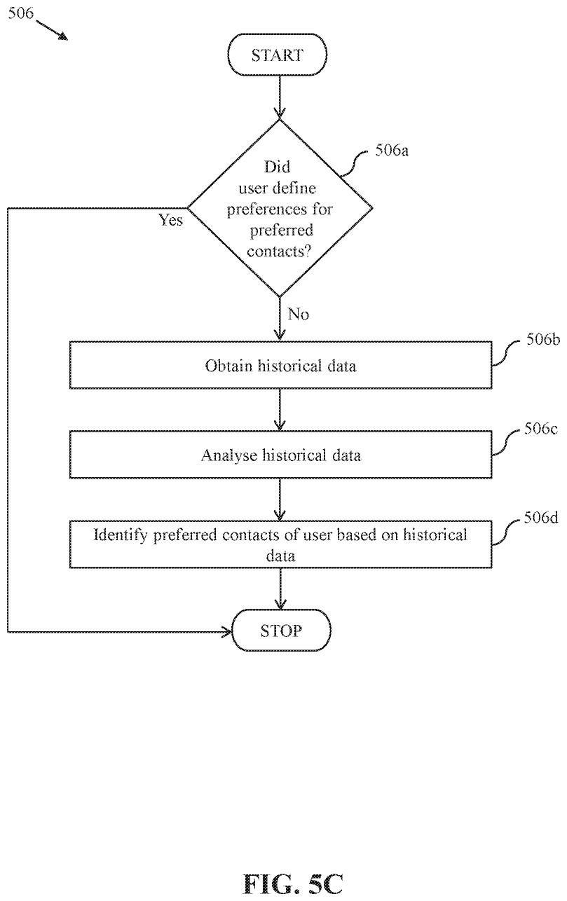

FIGS. 5A and 5B are diagrams that collectively represent a flow chart 500 that illustrates a safety and security method for users in the vehicle 106, in accordance with an exemplary embodiment of the present disclosure. At 502, an emergency input initiated by the user 102 is detected. In an embodiment, the vehicle device 108 (or the application server 110) may be configured to detect the emergency input initiated by the user 102. The user 102 may initiate the emergency input by pressing the in-vehicle emergency button, by using the service application running on the user device 104, by uttering the one or more keywords, or any combination thereof. At 504, the camera device 212 is activated. In an embodiment, the vehicle device 108 (or the application server 110) may be configured to activate the camera device 212 for recording real-time audiovisual information corresponding to the one or more in-vehicle activities associated with at least one of the user 102 or the vehicle 106. The camera device 212 may be activated in response to the detected emergency input. At 506, preferred contacts are determined. In an embodiment, the vehicle device 108 (or the application server 110) may be configured to determine the preferred contacts of the user 102.

Referring now to FIG. 5C, at 506a, the vehicle device 108 determines whether the user 102 has defined one or more preferences for the preferred contacts. If at 506a, it is determined that the user 102 has defined the one or more preferences for the preferred contacts, then 508 is performed. If at 506a, it is determined that the user 102 has not defined the one or more preferences for the preferred contacts, then 506b is performed. At 506b, historical data of the user 102 is obtained. In an embodiment, the vehicle device 108 (or the application server 110) may be configured to obtain the historical data (such as historical call log, historical message log, or historical social media data including the social media profile) of the user 102 either from the user device 104 by using the service application or the database server 112. At 506c, the historical data is analyzed. In an embodiment, the vehicle device 108 (or the application server 110) may be configured to analyze the historical data of the user 102 for identifying or determining the preferred contacts of the user 102. At 506d, the preferred contacts are identified. In an embodiment, the vehicle device 108 (or the application server 110) may be configured to identify or determine the preferred contacts of the user 102 from a list of identified contacts based on the analysis of the historical data. Upon determination of the preferred contacts, 508 is performed.

Referring back to FIGS. 5A and 5B, at 508, a streaming signal is communicated. In an embodiment, the vehicle device 108 (or the application server 110) may be configured to communicate the streaming signal to the preferred contacts of the user 102. The streaming signal facilitates live streaming or broadcasting of the real-time audiovisual information to the preferred contacts. At 510, the real-time audiovisual information is processed. In an embodiment, the vehicle device 108 (or the application server 110) may be configured to process the real-time audiovisual information (such as the recorded in-vehicle activities) to detect one or more emergency incidents. The vehicle device 108 may analyze the real-time audio and video data of the recorded audiovisual information to detect one or more threats or security concerns.

At 512, a priority level is assigned to each emergency incident. In an embodiment, the vehicle device 108 (or the application server 110) may be configured to analyze a degree of severity of each emergency incident and accordingly assign the priority level to each emergency incident. For example, if the degree of severity is high, then a high priority is assigned to the emergency incident such as “accident” or “attacks”. At 514, an alert signal is generated. In an embodiment, the vehicle device 108 (or the application server 110) may be configured to generate the alert signal based on the detected one or more emergency incidents. In an embodiment, the vehicle device 108 (or the application server 110) may be further configured to generate the alert signal based on the priority level of each of the one or more emergency incidents. At 516, real-time location of the vehicle 106 is detected. In an embodiment, the vehicle device 108 (or the application server 110) may be configured to detect the real-time location of the vehicle 106. The real-time location may be detected based on location information received from the sensor grid 214 (such as the location sensors installed in the vehicle 106) or the user device 104 (by using the service application). The real-time location may indicate the current location (i.e., an incident location) of the vehicle 106. At 518, one or more entities are identified. In an embodiment, the vehicle device 108 (or the application server 110) may be configured to identify the one or more entities based on the current location of the vehicle 106. The one or more entities (such as the one or more passer-by individuals, near-by vehicles, and emergency response teams) may be identified from a set of entities based on the current location of the vehicle 106. At 520, the alert signal is communicated to the one or more entities. In an embodiment, the vehicle device 108 (or the application server 110) may be configured to communicate the alert signal to the one or more entities for initiating one or more rescue operations. The vehicle device 108 may communicate the alert signal to the one or more entities such as the one or more emergency response teams, passer-by individuals, and nearby vehicles. The alert signal may be communicated along with the real-time audiovisual information to the one or more entities. Further, the location information is also communicated to the one or more entities along with the alert signal and the real-time audiovisual information. In a scenario where the one or more entities may come forward to provide the one or more rescue operations, the ride-hailing service provider platform may offer one or more rewards to the one or more entities. The one or more rewards may include at least a flat discount for a ride, a distance-based discount for a ride, a time-based discount for a ride, a reward point, or a free ride offer. The one or more rewards may be customized based on the assigned priority.

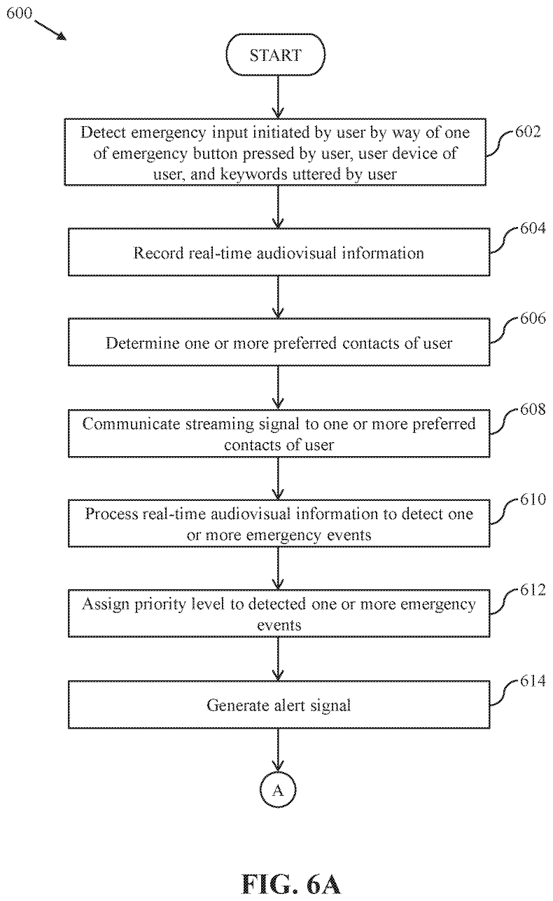

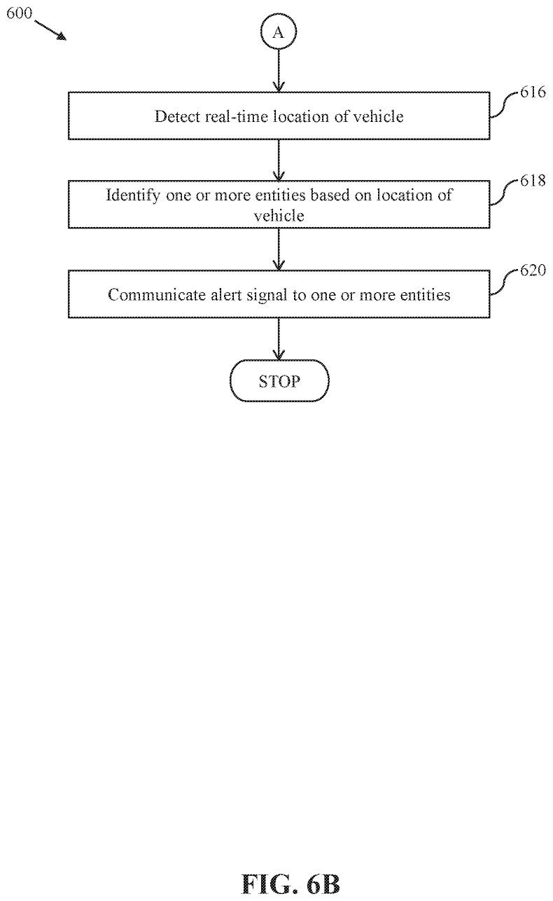

FIGS. 6A-6B are diagrams that collectively represent a flow chart 600 that illustrates a safety and security method for users in the vehicle 106, in accordance with another exemplary embodiment of the present disclosure. At 602, the emergency input initiated by the user 102 is detected. In an embodiment, the camera device 212 may be configured to detect the emergency input initiated by the user 102. The user 102 may initiate the emergency input by pressing the in-vehicle emergency button, by using the service application running on the user device 104, by uttering the one or more keywords, or any combination thereof. At 604, the real-time audiovisual information is recorded. In an embodiment, the camera device 212 may be configured to record the real-time audiovisual information corresponding to the one or more in-vehicle activities associated with at least one of the user 102 or the vehicle 106. The camera device 212 may record the real-time audiovisual information in response to the detected emergency input. At 606, the preferred contacts are determined. In an embodiment, the camera device 212 may be configured to determine the preferred contacts of the user 102 in a manner similar to that described in FIG. 5C.

At 608, the streaming signal is communicated. In an embodiment, the camera device 212 may be configured to communicate the streaming signal to the preferred contacts of the user 102. The streaming signal facilitates live streaming or broadcasting of the real-time audiovisual information to the preferred contacts. At 610, the real-time audiovisual information is processed. In an embodiment, the camera device 212 may be configured to process the real-time audiovisual information (such as the recorded in-vehicle activities) to detect the one or more emergency incidents. The camera device 212 may analyze the real-time audio and video data of the recorded audiovisual information to detect the one or more threats or security concerns.

At 612, the priority level is assigned to each emergency incident. In an embodiment, the camera device 212 may be configured to analyze the degree of severity of each emergency incident and accordingly assign the priority level to each emergency incident. At 614, the alert signal is generated. In an embodiment, the v camera device 212 may be configured to generate the alert signal based on the detected one or more emergency incidents. In an embodiment, the camera device 212 may be further configured to generate the alert signal based on the priority level of each of the one or more emergency incidents. At 616, the real-time location of the vehicle 106 is detected. In an embodiment, the camera device 212 may be configured to detect the real-time location of the vehicle 106. The real-time location may be detected based on location information received from the sensor grid 214 (such as the location sensors installed in the vehicle 106) or the user device 104 (by using the service application). The real-time location may indicate the current location (i.e., an incident location) of the vehicle 106. At 618, the one or more entities are identified. In an embodiment, the camera device 212 may be configured to identify the one or more entities based on the current location of the vehicle 106. The one or more entities (such as the one or more passer-by individuals, near-by vehicles, and emergency response teams) may be identified from the set of entities based on the current location of the vehicle 106. At 620, the alert signal is communicated to the one or more entities. In an embodiment, the camera device 212 may be configured to communicate the alert signal to the one or more entities for initiating the one or more rescue operations. The camera device 212 may communicate the alert signal to the one or more entities such as the one or more emergency response teams, passer-by individuals, and nearby vehicles. The alert signal may be communicated along with the real-time audiovisual information to the one or more entities. Further, the location information is also communicated to the one or more entities along with the alert signal and the real-time audiovisual information. In a scenario where the one or more entities may come forward to provide the one or more rescue operations, the ride-hailing service provider platform may offer the one or more rewards to the one or more entities. The one or more rewards may include at least a flat discount for a ride, a distance-based discount for a ride, a time-based discount for a ride, a reward point, or a free ride offer. The one or more rewards may be customized based on the assigned priority.

Thus, the present disclosure facilitates enhanced safety and security measures to one or more users (such as the user 102) of a vehicle (such as the vehicle 106) by capturing and processing real-time in-vehicle activities to detect one or more emergency incidents. In a scenario where an emergency incident is detected, an alert signal is generated and communicated to one or more rescue entities such as one or more passer-by individuals, near-by vehicles, and emergency response teams, who may come forward to offer one or more rescue operations. Thus, the present disclosure facilitates immediate assistance to the one or more users that can result in saving their lives and minimizing any other collateral damages resulting therefrom. Also, with the implementation of these safety and security measures in the vehicle 106, especially, 3-wheeler auto-rickshaws, various individuals, such as intruders, attackers, molesters, or the like, are discouraged from behaving improperly with the one or more users. Thus, the present disclosure facilitates a sense of enhanced safety and security to the one or more users of the vehicle 106. The one or more users feel safe and secure during their rides.

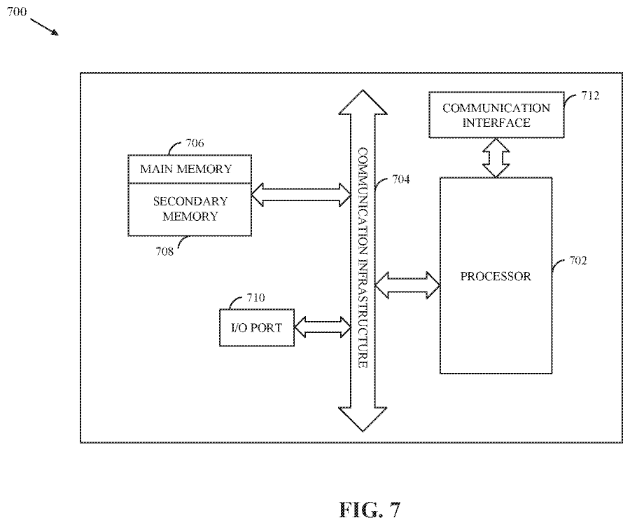

FIG. 7 is a block diagram that illustrates a system architecture of a computer system 700 for facilitating safety and security features to the users of the vehicle 106, in accordance with an exemplary embodiment of the present disclosure. An embodiment of the present disclosure, or portions thereof, may be implemented as computer readable code on the computer system 700. In one example, the vehicle device 108, the application server 110, and the database server 112 of FIG. 1 and the camera device 212 of FIG. 2 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 5A-5C and 6A-6B.

The computer system 700 includes a processor 702 that may be a special purpose or a general-purpose processing device. The processor 702 may be a single processor, multiple processors, or combinations thereof. The processor 702 may have one or more processor “cores.” Further, the processor 702 may be coupled to a communication infrastructure 704, such as a bus, a bridge, a message queue, the communication network 114, multi-core message-passing scheme, or the like. The computer system 700 further includes a main memory 706 and a secondary memory 708. Examples of the main memory 706 may include random access memory (RAM), read-only memory (ROM), and the like. The secondary memory 708 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

The computer system 700 further includes an input/output (I/O) port 710 and a communication interface 712. The I/O port 710 includes various input and output devices that are configured to communicate with the processor 702. Examples of the input devices may include a keyboard, a mouse, a joystick, a touchscreen, a microphone, and the like. Examples of the output devices may include a display screen, a speaker, headphones, and the like. The communication interface 712 may be configured to allow data to be transferred between the computer system 700 and various devices that are communicatively coupled to the computer system 700. Examples of the communication interface 712 may include a modem, a network interface, i.e., an Ethernet card, a communications port, and the like. Data transferred via the communication interface 712 may be signals, such as electronic, electromagnetic, optical, or other signals as will be apparent to a person skilled in the art. The signals may travel via a communications channel, such as the communication network 114 which may be configured to transmit the signals to the various devices that are communicatively coupled to the computer system 700. Examples of the communication channel may include, but are not limited to, cable, fiber optics, a phone line, a cellular phone link, a radio frequency link, a wireless link, and the like.

Computer program medium and computer usable medium may refer to memory, such as the main memory 706 and the secondary memory 708, which may be a semiconductor memory such as dynamic RAMs. These computer program mediums may provide data that enables the computer system 700 to implement the methods illustrated in FIGS. 5A-5C and 6A-6B. In an embodiment, the present disclosure is implemented using a computer implemented application. The computer implemented application may be stored in a computer program product and loaded into the computer system 700 using the removable storage drive or the hard disc drive in the secondary memory 708, the I/O port 710, or the communication interface 712. The main memory 706 and the secondary memory 708 may refer to non-transitory computer readable mediums that may provide data that enables the computer system 700 to implement the safety and security methods illustrated in FIGS. 5A-5C and 6A-6B.

Various embodiments of the present disclosure provide a non-transitory computer readable medium having stored thereon, computer executable instructions, which when executed by a computer, cause the computer to execute operations for providing safety and security measures or features to one or more users (such as the user 102) of a vehicle (such as the vehicle 106) during a ride. The operations include detecting, by circuitry, an emergency input initiated by the user 102 in the vehicle 106. The emergency input may be initiated by using one of an in-vehicle emergency button in the vehicle 106, a service application running on the user device 104 of the user 102, or a set of keywords uttered by the user 102. The operations further include activating, by the circuitry, the camera device 212 of the vehicle 106 for capturing and recording real-time audiovisual information of in-vehicle activities in response to the emergency input. The operations further include communicating, by the circuitry, a streaming signal, for streaming the real-time audiovisual information, to one or more preferred contacts of the user 102 based on one or more identifiers associated with each preferred contact. The operations further include processing, by the circuitry, the recorded audiovisual information to detect one or more emergency events associated with at least one of the user 102 or the vehicle 106. The operations further include generating, by the circuitry, an alert signal based on the detected one or more emergency events. The operations further include communicating, by the circuitry, the alert signal along with the real-time audiovisual information to one or more entities including one or more passer-by individuals, near-by vehicles, and emergency response teams.

The operations further include receiving, by the circuitry, location information by means of one or more location sensors installed in the vehicle 106 or the user device 104. The operations further include identifying, by the circuitry, the one or more entities from a set of entities based on at least the location information. Further, the location information may be further communicated to the one or more entities along with the alert signal and the real-time audiovisual information. The operations further include determining, by the circuitry, the one or more preferred contacts of the user 102 based on preferences for one or more contacts defined by the user 102 by using the service application. Alternatively, the operations further include determining, by the circuitry, the one or more preferred contacts of the user 102 based on a call log, a message log, and a social media profile associated with the user 102. The operations further include assigning, by the circuitry, a priority to the alert signal based on a degree of severity associated with each of the one or more emergency events. The user 102, the vehicle 106, and the one or more entities may be registered with a ride-hailing service provider platform. The ride-hailing service provider platform may offer one or more rewards, including at least a flat discount for a ride, a distance-based discount for a ride, a time-based discount for a ride, a reward point, or a free ride offer, to the one or more entities who offer one or more rescue operations corresponding to the one or more emergency events. The one or more rewards may be customized based on the assigned priority.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor, such as the processor 702, and a memory, such as the main memory 706 and the secondary memory 708, implement the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for providing safety and security measures or features to one or more users (such as the user 102) of a vehicle (such as the vehicle 106). Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed systems and methods have been described above, it should be understood that they have been presented for purposes of example only, not limitations. It is not exhaustive and does not limit the present disclosure to the precise form disclosed. Modifications and variations are possible in light of the above teachings or may be acquired from practicing of the present disclosure, without departing from the breadth or scope.

What is claimed is:

1. A method, comprising:
detecting, by circuitry, an emergency input initiated by a user in a vehicle, wherein the emergency input is initiated by using one of an in-vehicle emergency button in the vehicle, a service application running on a user device of the user, or a set of keywords uttered by the user;
activating, by the circuitry, a camera device of the vehicle for capturing and recording real-time audiovisual information of in-vehicle activities in response to the emergency input;
communicating, by the circuitry, a streaming signal, for streaming the real-time audiovisual information, to one or more preferred contacts of the user based on one or more identifiers associated with each preferred contact;
processing, by the circuitry, the recorded audiovisual information to detect one or more emergency events associated with at least one of the user or the vehicle;
generating, by the circuitry, an alert signal based on the detected one or more emergency events; and
communicating, by the circuitry, the alert signal along with the real-time audiovisual information to one or more entities including one or more passer-by individuals, near-by vehicles, and emergency response teams.

2. The method of claim 1, further comprising receiving, by the circuitry, location information by means of one or more location sensors installed in the vehicle or the user device.

3. The method of claim 2, further comprising identifying, by the circuitry, the one or more entities from a set of entities based on at least the location information, wherein the location information is further communicated to the one or more entities along with the alert signal and the real-time audiovisual information.

4. The method of claim 1, further comprising determining, by the circuitry, the one or more preferred contacts of the user based on preferences for one or more contacts defined by the user by using the service application.

5. The method of claim 1, further comprising determining, by the circuitry, the one or more preferred contacts of the user based on a call log, a message log, and a social media profile associated with the user.

6. The method of claim 1, further comprising assigning, by the circuitry, a priority to the alert signal based on a degree of severity associated with each of the one or more emergency events.

7. The method of claim 6, wherein the user, the vehicle, and the one or more entities are registered with a ride-hailing service provider platform, wherein the ride-hailing service provider platform offers one or more rewards, including at least a flat discount for a ride, a distance-based discount for a ride, a time-based discount for a ride, a reward point, or a free ride offer, to the one or more entities who offer one or more rescue operations corresponding to the one or more emergency events, and wherein the one or more rewards are customized based on the assigned priority.

8. A system, comprising:
circuitry configured to:
detect an emergency input initiated by a user in a vehicle, wherein the emergency input is initiated by using one of an in-vehicle emergency button in the vehicle, a service application running on a user device of the user, or a set of keywords uttered by the user;
activate a camera device of the vehicle for capturing and recording real-time audiovisual information of in-vehicle activities in response to the emergency input;
communicate a streaming signal, for streaming the real-time audiovisual information, to one or more preferred contacts of the user based on one or more identifiers associated with each preferred contact;
process the recorded audiovisual information to detect one or more emergency events associated with at least one of the user or the vehicle;
generate an alert signal based on the detected one or more emergency events; and
communicate the alert signal along with the real-time audiovisual information to one or more entities including one or more passer-by individuals, near-by vehicles, and emergency response teams.

9. The system of claim 8, wherein the circuitry is further configured to receive location information by means of one or more location sensors installed in the vehicle or the user device.

10. The system of claim 9, wherein the circuitry is further configured to identify the one or more entities from a set of entities based on at least the location information, wherein the location information is further communicated to the one or more entities along with the alert signal and the real-time audiovisual information.

11. The system of claim 8, wherein the circuitry is further configured to determine the one or more preferred contacts of the user based on preferences for one or more contacts defined by the user by using the service application.

12. The system of claim 8, wherein the circuitry is further configured to determine the one or more preferred contacts of the user based on at least one of a call log, a message log, or a social media profile associated with the user.

13. The system of claim 8, wherein the circuitry is further configured to assign a priority to the alert signal based on a degree of severity associated with each of the one or more emergency events.

14. The system of claim 13, wherein the user, the vehicle, and the one or more entities are registered with a ride-hailing service provider platform, wherein the ride-hailing service provider platform offers one or more rewards, including at least a flat discount for a ride, a distance-based discount for a ride, a time-based discount for a ride, a reward point, or a free ride offer, to the one or more entities who offer one or more rescue operations corresponding to the one or more emergency events, and wherein the one or more rewards are customized based on the assigned priority.

15. A camera device in a vehicle, the camera device comprising:
circuitry configured to:
detect an emergency input initiated by a user in a vehicle, wherein the emergency input is initiated by using one of an in-vehicle emergency button in the vehicle, a service application running on a user device of the user, or a set of keywords uttered by the user;
capture and record real-time audiovisual information of in-vehicle activities in response to the emergency input;
communicate a streaming signal, for streaming the real-time audiovisual information, to one or more preferred contacts of the user based on one or more identifiers associated with each preferred contact;
process the recorded audiovisual information to detect one or more emergency events associated with at least one of the user or the vehicle;
generate an alert signal based on the detected one or more emergency events; and
communicate the alert signal along with the real-time audiovisual information to one or more entities including one or more passer-by individuals, near-by vehicles, and emergency response teams.

16. The camera device of claim 15, wherein the circuitry is further configured to receive location information by means of one or more location sensors installed in the vehicle or the user device.

17. The camera device of claim 16, wherein the circuitry is further configured to identify the one or more entities from a set of entities based on at least the location information, wherein the location information is further communicated to the one or more entities along with the alert signal and the real-time audiovisual information.

18. The camera device of claim 15, wherein the one or more identifiers associated with each of the one or more preferred contacts include at least a user's name, a user's email, and a user's contact number.

19. The camera device of claim 18, wherein the circuitry is further configured to determine the one or more preferred contacts of the user based on at least one of:
preferences for one or more contacts defined by the user by using the service application, or
a call log, a message log, or a social media profile associated with the user.

20. The camera device of claim 15, wherein the user, the vehicle, and the one or more entities are registered with a ride-hailing service provider platform, wherein the ride-hailing service provider platform offers one or more rewards, including at least a flat discount for a ride, a distance-based discount for a ride, a time-based discount for a ride, a reward point, or a free ride offer, to the one or more entities who offer one or more rescue operations corresponding to the one or more emergency events, and wherein the one or more rewards are customized based on a priority of the alert signal.
